(19) United States
(12) Patent Application Publication
(10) Pub. No.: US 2012/0177898 A1
(43) Pub. Date: Jul. 12, 2012

(54) APPARATUS AND METHOD FOR ORIENTING AN ADHESIVE NOTE

(76) Inventor: Don STOKES, Marshall, TX (US)

(21) Appl. No.: 12/987,834

(22) Filed: Jan. 10, 2011

(51) Int. Cl. C09J 7/04; B32B 37/12; B32B 38/14; B32B 3/10; C09J 7/02

(52) U.S. Cl. 428/211.1; 428/195.1; 156/64

(57) ABSTRACT

An adhesive note apparatus is disclosed, comprising a note with a front side and a rear side, a directional indicator marking printed or otherwise attached to the front side, and an adhesive covering some portion of the rear side.

### BACKGROUND

Adhesive notes are used broadly in home and office environments. In many instances, the proper orientation of these notes is not readily apparent at first glance. This can be due to the fact that a particular note is made in a rotationally symmetrical shape, such as a circle or a square, so that it appears the same in one or more orientations. This can also be due to the fact that the location of the adhesive, which is often regarded as the top of a note, is not visible when viewing a note from the front. In these cases, it is possible to create confusion and misunderstanding by placing markings on a note in an incorrect orientation, or by adhering a note to a surface in an incorrect fashion, such as upside-down.

### SUMMARY OF THE INVENTION

In one exemplary embodiment, an adhesive note is disclosed. The note can have a front side and a rear side. The rear side can contain adhesive. An arrow or other directional indicator marking can be printed or otherwise attached to the front side.

In another exemplary embodiment, a method for orienting an adhesive note is disclosed. This method can include printing or otherwise affixing a directional indicator marking on an adhesive note, adhering the adhesive note to a surface, and indicating the proper orientation of the adhesive note with the directional indicator marking.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is a front view of an exemplary embodiment of an adhesive note.

FIG. 2 is a rear view of an exemplary embodiment of an adhesive note.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

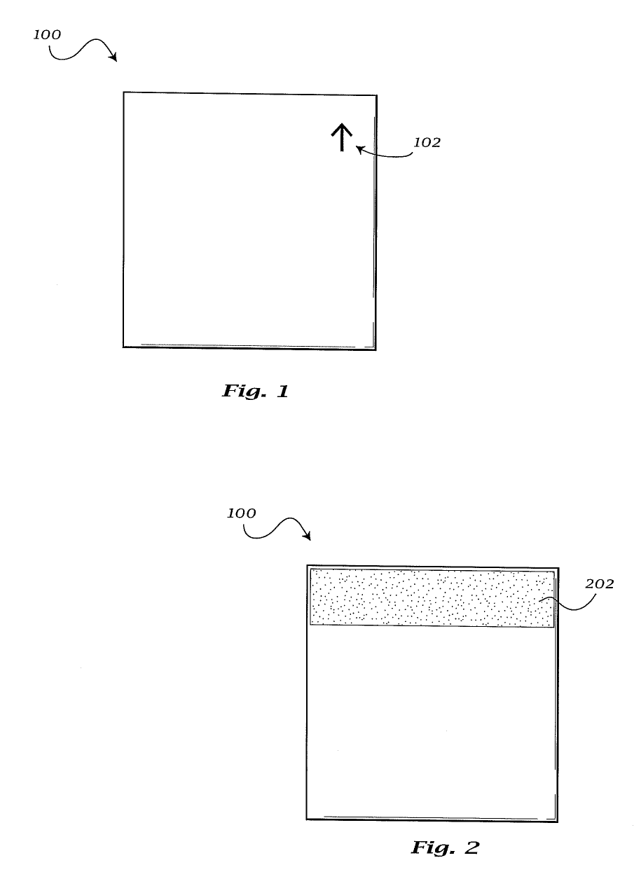

Exemplary FIGS. 1-2 generally relate to an adhesive note that can include an indicator marking. The marking can be used to indicate the correct orientation of the adhesive note with respect to the placement of the note on various surfaces, the placement writings or drawings on the note, the location of the adhesive on the rear side of the note, or for any other desired purpose.

One exemplary embodiment of an adhesive note 100 is shown as an example in FIG. 1. Adhesive note 100 can be constructed of paper, plastic, or any other material. Adhesive note 100 can be approximately square, or can be shaped in any other fashion, for instance as a rectangle, triangle, circle, or oval. Adhesive note 100 can be sized to fit conveniently on a document, for example approximately 3 inches per side, or it can be of any other size, to facilitate placement on any other surface or object.

Adhesive note 100 can contain a front side and a rear side. The front side of adhesive note 100 can contain an area on which markings such as notes or drawings can be made. These markings can be made with pencils, pens, markers, or any other desired marking instrument. The front side of adhesive note 100 can also contain an indicator 102. Indicator 102 can be an arrow or any other type of marking that indicates direction. Indicator 102 can be printed on the front side of adhesive note 100, or it can be attached or affixed in any other manner. Indicator 102 can be located anywhere on the front side of adhesive note 100, for example in one corner.

Exemplary FIG. 2 illustrates the rear side of an exemplary embodiment of adhesive note 100. An adhesive 202 can be disposed along the rear side of adhesive note 100. Adhesive 202 can cover substantially all of the rear side of adhesive note 100, or it can cover only a portion of the rear side. Adhesive 202 can for instance be located substantially adjacent to one or more edges of the rear side of adhesive note 100. Adhesive 202 can adhere to a variety of surfaces, for instance paper, plastic, wood, glass, or any other surface. Adhesive note 100 can therefore be placed on and adhere to a variety of objects, including documents, boxes, desks, tables, walls, counters, appliances, or any other desired object. Adhesive 202 can be removable, and can retain its adhesive properties allowing adhesive note 100 to be placed and removed multiple times on multiple surfaces. Adhesive note 100 can be attached to one or more other adhesive notes using adhesive 202 or some other attachment method. In this way, multiple adhesive notes can be bundled together, for example as a pad, for convenience as desired. Further, in some exemplary embodiments, the notes may be numbered.

In an exemplary embodiment, indicator 102 can be used to specify a direction in order to facilitate the proper orientation of adhesive note 100. The direction specified by indicator 102 can be used to indicate the direction in which adhesive note 100 should be oriented when placed on a surface. The direction specified by indicator 102 can also be used to indicate the direction in which other markings, such as notes, should be made on adhesive note 100. The direction specified by indicator 102 can also be used to indicate the location of adhesive 202 on the rear side of adhesive note 100.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An adhesive note apparatus, comprising:
a note, with a front side and a rear side;
a directional indicator marking printed or otherwise affixed to the front side; and
an adhesive covering some portion of the rear side substantially opposite the directional indicator.

2. The apparatus of claim 1, wherein the note is constructed of paper.

3. The apparatus of claim 1, wherein the note is generally square.

4. The apparatus of claim 1, wherein the note measures approximately 3 inches per side.

5. The apparatus of claim 1, wherein the directional indicator marking is in the shape of an arrow.

6. The apparatus of claim 1, wherein the directional indicator marking is located near one corner of the note.

7. The apparatus of claim 1, wherein the adhesive covers substantially all of the rear side.

8. The apparatus of claim 1, wherein the adhesive covers only a portion of the rear side.

9. The apparatus of claim 8, wherein the portion covered by the adhesive is substantially along one edge of the note.

10. The apparatus of claim 1, wherein the adhesive can adhere to at least one of paper, plastic, wood, or glass.

11. The apparatus of claim 1, wherein the adhesive is removable and retains its adhesive qualities, allowing the note to be placed and removed one or more times on one or more surfaces.

12. The apparatus of claim 1, wherein the adhesive note is attached to one or more similar adhesive notes.

13. An method for orienting an adhesive note, comprising:
providing a directional indicator marking on an adhesive note;
adhering the adhesive note to a surface; and
indicating the proper orientation of the adhesive note with the directional indicator marking.

14. The method of claim 13, further comprising making markings such as writings or drawings on the note.

15. The method of claim 14, further comprising indicating the proper orientation of the writings or drawings using the directional indicator marking.

16. The method of claim 13, further comprising indicating the location of the adhesive on the note using the directional indicator marking.
